(19) United States
(12) Patent Application Publication
(10) Pub. No.: US 2003/0193706 A1
(43) Pub. Date: Oct. 16, 2003

(54) System and method for minimizing interferometric distortion in directly modulated analog fiber optic links

(76) Inventors: Willie W. Ng, Agoura Hills, CA (US); David L. Persechini, Santa Monica, CA (US); Robert H. Buckley, Santa Ana, CA (US)

Correspondence Address: Leonard A. Alkov, Raytheon Company, P.O. Box 902 (E1/E150), El Segundo, CA, 90245-0902, US

(21) Appl. No.: 10/120,615

(22) Filed: Apr. 11, 2002

(51) Int. Cl. G02F 1/01; G02B 26/00

(52) U.S. Cl. 359/238

(57) ABSTRACT

A method for minimizing the generation of interferometric intermodulation distortion in an analog fiber optic link that employs a directly modulated diode laser as its optical source. This is accomplished via the reduction of frequency chirp in the current-modulated diode laser source (32). To reduce frequency chirp, the diode laser (32) is coupled to an external reflector (52), so that an external laser cavity with a long, passive section is formed. Specifically, the frequency chirp of this extended laser cavity is reduced from that of the original diode laser by the ratio of the optical path length in the external cavity to that in the diode. The external reflector (52) can also be integrated, via splicing, to the fiber pigtail (54) of the laser transmitter (50) so that the compact geometric form factor of a diode transmitter is preserved.

### BACKGROUND OF THE INVENTION

1. Field of the Invention

The present invention relates to optical systems. More specifically, the present invention relates to systems and methods for minimizing interferometric distortion in directly modulated fiber optic links.

2. Description of the Related Art

In a fiber optic transmission system, an RF (radio frequency) signal is often modulated onto an optical carrier and delivered subsequently to a remote site for additional processing via an optical link. During the modulation and transmission process, undesirable intermodulation products can be generated, corrupting the fidelity of the transmitted signal.

A viable method for reducing intermodulation distortion—in particular, those originating from interferometric effects—is to employ an externally modulated link. Many systems currently use this approach; however, it has several undesirable properties. In particular, the manner by which the electro-optic modulator is designed requires a relatively expensive polarization maintaining fiber at the input end thereof. Secondly, the external modulator itself is fairly expensive, resulting in an impetus to replace it with a less costly solution.

One approach is to use a directly modulated diode laser as the optical source. With this approach, the CW laser and the external modulator are replaced by a single component, a directly modulated diode laser. The RF input signal is transmitted by current modulation of the diode laser to the optical fiber. This is the desirable approach to replace the more expensive externally modulated link used in present systems.

Unfortunately, the directly modulated approach suffers from corruption of the transmission signal due to interferometric distortion. To mitigate this undesirable effect, an optical isolator is typically placed between the diode laser and its fiber pigtail. The use of an optical isolator, however, increases the complexity of the optics needed to efficiently couple the emission of the diode laser to the optical fiber. Furthermore, optical isolators are typically specified to operate over limited temperature ranges. In practice, the coupling efficiencies measured—with passage through these isolators—could also vary with temperature because of differences in the coefficients of thermal expansion between the laser mount, lens/isolator mount and fiber-anchor in the transmitter package.

Hence, a need exists in the art for an improved method or system for minimizing the generation of interferometric intermodulation distortion in a directly modulated fiber optic link which is lower in cost and which can maintain a high efficiency over a wider temperature range than conventional approaches.

### SUMMARY OF THE INVENTION

The need in the art is addressed by the system and method for minimizing interferometric intermodulation distortion in an analog fiber optic link employing a directly modulated diode laser as its optical source of the present invention. In particular, the need is addressed via the reduction of frequency chirp in the current-modulated diode laser source.

In the illustrative embodiments, to reduce frequency chirp, the diode laser is coupled to an external reflector, so that an external laser cavity with a long, passive section is formed. Specifically, the frequency chirp of this extended laser cavity is reduced from that of the original diode laser by the ratio of the optical path length in the external cavity to that in the diode. The external reflector can also be integrated, via splicing, to the fiber pigtail of the laser transmitter so that the compact geometric form factor of a diode transmitter is preserved. By reducing the chirp of the diode laser via external feedback, a dramatic reduction (by as much as 20-30 dB) of the third order intermodulation distortion (IM3) can be achieved.

### BRIEF DESCRIPTION OF THE DRAWINGS

FIG. 1 shows a schematic of an externally modulated analog fiber optic link 10 of conventional design and construction.

FIG. 2 shows a schematic of a directly modulated analog fiber optic link 30 of conventional design and construction.

FIG. 3 shows a schematic of a directly modulated transmitter 40 with an optical isolator of conventional design and construction.

FIG. 4 is an illustration showing the generation of interferometric intermodulation distortion in a directly modulated analog fiber optic link.

FIG. 5 is a diagram showing a low chirp laser transmitter designed in accordance with the teachings of the present invention.

FIG. 6 shows a schematic of an external reflector integrated with the fiber pigtail of the laser transmitter in accordance with the teachings of the present invention.

FIG. 7 is a diagram showing a directly modulated fiber optic transmission system using a laser transmitter with an external reflector in accordance with teachings of the present invention.

FIG. 8 is a graph showing a comparison of experimentally measured IM3 distortion for a directly modulated link with and without the chirp reduction technique of the present invention.

FIG. 9 is a graph showing a comparison of experimentally measured IM3 distortion for a directly modulated link with and without chirp reduction via a fiber-integrated external reflector.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility. As mentioned above, the conventional method for reducing intermodulation distortion is to use an externally modulated link.

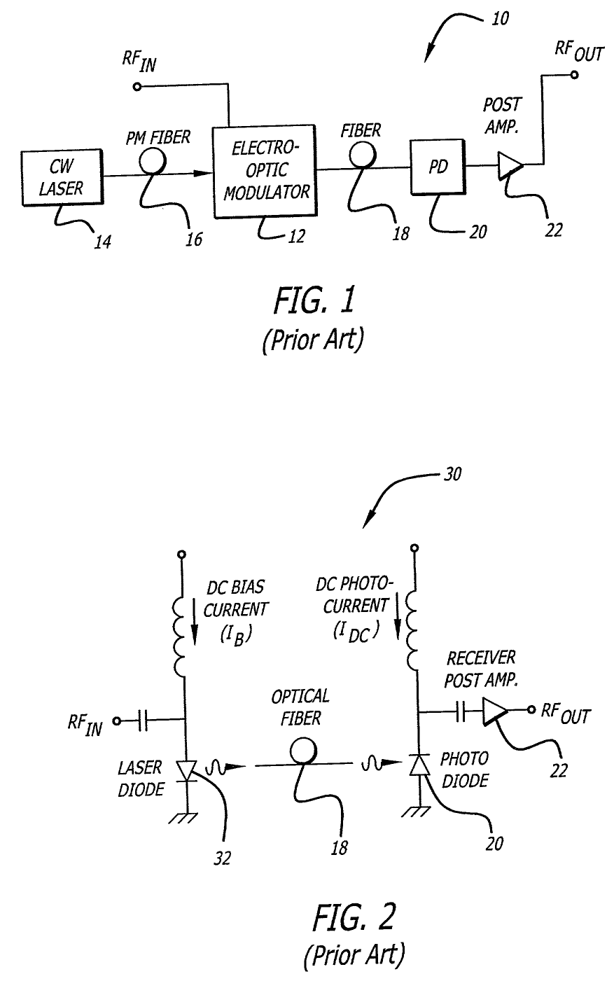

FIG. 1 shows a schematic of an externally modulated analog fiber optic link 10 of conventional design and construction. In the transmission system 10 of FIG. 1, an input signal RF_{IN} is modulated onto an optical carrier by an external electro-optic modulator 12. A CW laser 14 generates the optical carrier signal, which is delivered to the electro-optic modulator 12 by a polarization maintaining (PM) fiber 16. The modulated signal is then transmitted through optical fiber 18 until it is detected and converted to an RF signal by a photodetector 20 and amplified by a post amplifier 22.

Many systems currently use this approach; however, it has several undesirable properties. In particular, because of the way the electro-optic modulator 12 is designed, the input end requires a relatively expensive polarization maintaining fiber 16. Second, the external modulator 12 itself is fairly expensive, so there is a need to replace it with a less costly solution. One approach is to use a directly modulated diode laser as the optical source.

FIG. 2 shows a schematic of a directly modulated analog fiber optic link 30 of conventional design and construction. Here, the CW laser and the external modulator are replaced by a single component, a directly modulated diode laser 32. The RF input signal is transmitted by current modulation of the diode laser 32 to the optical fiber 18. This is the preferred approach to replace the more expensive externally modulated link used in present systems.

Unfortunately, with the directly modulated approach there is some corruption of the transmission signal due to interferometric distortion. To mitigate this undesirable effect, an optical isolator is typically placed between the diode laser and its fiber pigtail.

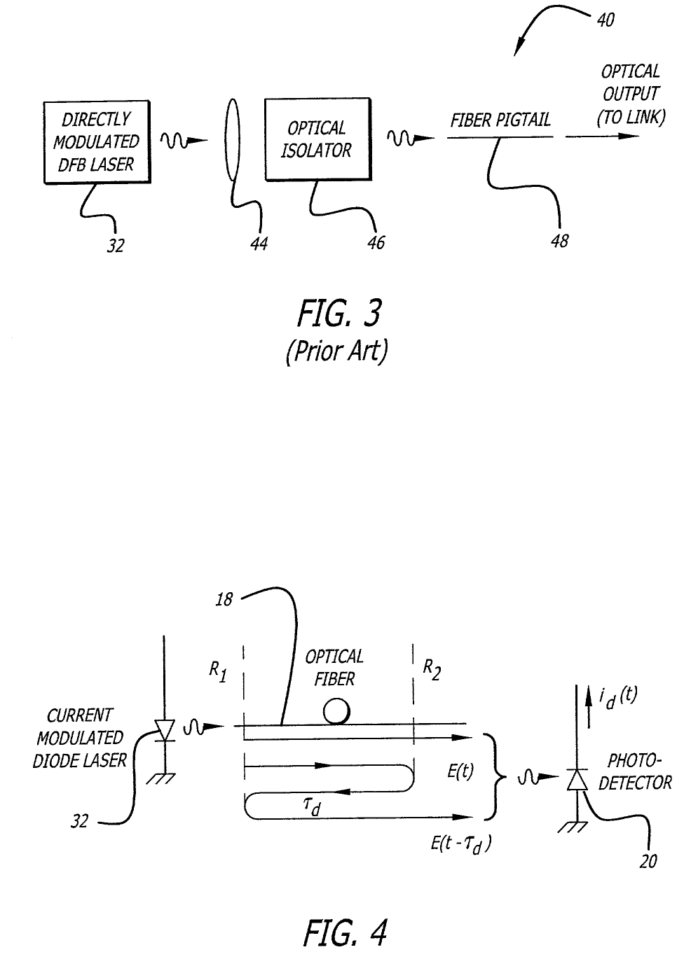

FIG. 3 shows a schematic of a directly modulated transmitter 40 with an optical isolator of conventional design and construction. In the transmitter 40 of FIG. 3, the output of a directly modulated distributed feedback (DFB) laser 32 is focused by a micro-lens 44 to an optical isolator 46. A fiber pigtail 48 connects the output of the optical isolator 46 to the optical fiber 18 of FIG. 2.

The use of an optical isolator, however, increases the complexity of the optics needed to efficiently couple the emission of the diode laser to the optical fiber. Furthermore, optical isolators are typically specified to operate over limited temperature ranges. In practice, the coupling efficiencies measured—with passage through these isolators—could also vary with temperature because of differences in the coefficients of thermal expansion between the laser mount, lens/isolator mount and fiber-anchor in the transmitter package.

Hence, a need has existed in the art for an improved method or system for minimizing the generation of interferometric intermodulation distortion in a directly modulated fiber optic link which is lower in cost and which can maintain a high efficiency over a wider temperature range than conventional approaches.

The present invention describes a new approach to minimize the generation of interferometric intermodulation distortion in an analog fiber optic link that employs a directly modulated diode laser as its optical source. That is, the above objective is accomplished via the reduction of frequency chirp in the current-modulated diode laser source. To reduce frequency chirp, the diode laser is coupled to an external reflector, so that an external laser cavity with a long, passive section is formed. Specifically, the frequency chirp of this extended laser cavity is reduced from that of the original diode laser by the ratio of the optical path length in the external cavity to that in the diode. The external reflector can also be integrated, via splicing, to the fiber pigtail of the laser transmitter so that the compact geometric form factor of a diode transmitter is preserved. By reducing the chirp of the diode laser via external feedback, a dramatic reduction (by as much as 20-30 dB) of the third order intermodulation distortion (IM3) can be achieved.

FIG. 4 is an illustration showing the generation of interferometric intermodulation distortion in a directly modulated analog fiber optic link. The occurrence of this extraneous distortion can be traced to a modulation in the optical oscillation frequency (ωₒ) of the diode laser (i.e. (ωₒ chirps), when current-modulation is exercised on the diode. (This phenomenon can be attributed, in turn, to the existence of significant coupling between the real and imaginary parts of the refractive index in the diode's active region.) If back-reflections (towards the laser) are present in the optical link (see FIG. 4), self-heterodyning—where the optical field E(t) from the laser beats against a time-delayed version E(t−τ_{d}) of itself—occurs at the photodetector in the link receiver. During this process, the photodetector acts as a mixer and converts the phase-modulation θ(t) in the diode's optical output to amplitude noise, with associated third order distortions for two tone inputs. Mathematically, the photodetector current i_{d}(t) due to this self-heterodyning process is given by:

i_{d}(t)˜Eₒ²{1+\sqrt{R₁R₂}cos[ωₒτ_{d}+θ(t)−θ(t−τ_{d})]} [1]

In the above expression, the phase modulation θ(t) that is responsible for the frequency chirping (Δf) in the diode is given by: θ(t)=βcos(ωₘt), where ωₘ=2πfₘ is the modulation frequency of the diode's drive current, and β=Δf/fₘ is the phase modulation index in the optical field E(t), with amplitude Eₒ.

Expanding Equation 1 for two-tone inputs, it can be found that the third order interferometric distortion (IM3) is proportional to [J₂(bₘ)J₁(bₘ)]² , where J₁ and J₂ are Bessel functions of the first and second order. Furthermore, the argument of these Bessel functions, bₘ, is

$${b}_{m} = β cos ( \frac{{ω}_{m} {τ}_{d}}{2} ) ,$$

where β is the phase-modulation index.

Since β=Δf/fₘ, the interferometric IM3 should be reduced if there is a reduction of the frequency chirp Δf. The typical frequency chirp observed for DFB lasers that emit at λ˜1300 nm is ˜150-250 MHz/mA. It is well known that the origin of frequency chirp in a diode laser is the modulation (Δn_{d}) in the real part of its refractive index (n_{d}˜3.52) that accompanies RF-modulation of its drive current. Since the lasing wavelength (λ) of the diode is given by λ=2n_{d}l_{d}/m′, where I_{d}(˜300 μm) is the physical length of the diode and m′ is an integer, λ varies with the modulation in n_{d}. The fractional wavelength chirp Δλ_{d} incurred in this process is given by:

$$\frac{Δ {λ}_{d}}{λ} = \frac{Δ {n}_{d}}{{n}_{d}} \qquad [ 2 ]$$

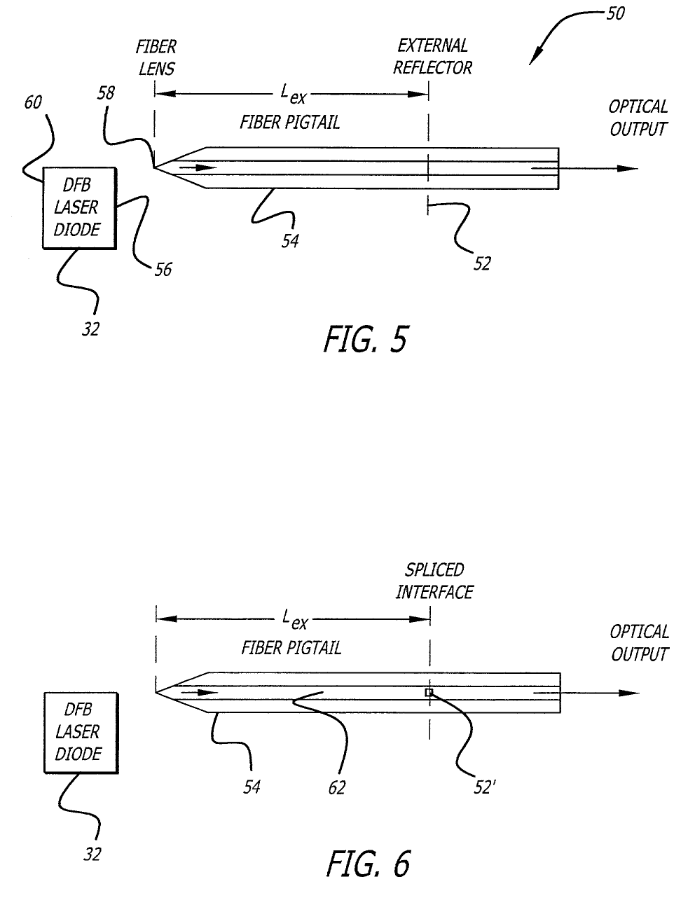

If the diode laser is coupled to an external reflector, as shown FIG. 5, the lasing wavelength λ becomes:

$$λ = \frac{2 \cdot ( {n}_{d} {l}_{d} + {n}_{ex} {L}_{ex} )}{m} ,$$

where nₑₓ (˜1.48) is the refractive index of the fiber coupling the diode to the external reflector (with reflectivity Rₑₓ), and an integer m. In effect, the external reflector forms an extended cavity with the original diode emitter.

Note, in particular, that this external cavity has a long passive section of length Lₑₓ, where Lₑₓ is typically cm's long. The wavelength chirp (Δλₑₓ) of this external cavity laser is now given by:

$$\frac{Δ {λ}_{ex}}{λ} = \frac{Δ {n}_{d}}{{n}_{ex}} \cdot \frac{{l}_{d}}{{L}_{ex}} \qquad [ 3 ]$$

Comparing Eq. 2 and Eq. 3, it can be shown that:

$$\frac{Δ {λ}_{ex}}{Δ {λ}_{d}} \approx \frac{{n}_{d} {l}_{d}}{{n}_{ex} {L}_{ex}} \qquad [ 4 ]$$

Therefore, the chirp in the laser transmitter of the present invention has been reduced by the ratio of the optical path length in the external laser cavity to that in the original diode cavity.

FIG. 5 is a diagram showing a low chirp laser transmitter 50 designed in accordance with the present teachings. The laser transmitter 50 is formed by coupling a distributed feedback laser diode 32 to an external reflector 52. A fiber lens 58 couples the diode emission to a fiber pigtail 54. The output facet 56 of the diode laser 32 is AR-coated. This is typically accomplished to (i) enhance the optical power coupled from the output facet, and (ii) improve the yield of single mode oscillation (for DFB lasers). This AR-coating reflectivity is typically 1-1.6%.

The external reflector 52, located a distance Lₑₓ away from the output facet 56 of the diode laser 32 with reflectivity Rₑₓ, feeds some of the light traveling through the fiber pigtail 54 back towards the diode laser 32. This forms an extended cavity between the external reflector 52 and the end 60 of the laser diode further away from the fiber. As discussed above, lengthening the laser cavity reduces chirping in the laser diode which is the root of the interferometric distortion.

Any method for generating reflectivity can be used to create the external reflector 52. The external reflector 52 can be an interface formed by two fibers of differing indices of refraction which produces a reflectivity sufficient to generate the feedback necessary to reduce distortion. The external reflector 52 can be integrated into the fiber pigtail 54, preserving the compact geometric form factor of a diode transmitter.

FIG. 6 shows a schematic of an external reflector integrated with the fiber pigtail of the laser transmitter in accordance with the teachings of the present invention. A thin film 52′ (e.g. Si or TiO₂) that has a refractive index n_{f} is deposited on the cleaved surface of a piece of fiber (with length equal to Lₑₓ). This short fiber section is then spliced to a longer fiber length to form a fiber pigtail 54 for our transmitter. As a result of the fusion splicing, an embedded external reflector 52′ with a thickness t is formed in the core 62 of the fiber pigtail 54. By controlling the thickness t via the thin film deposition procedure, the reflectivity Rₑₓ of this integrated reflector can be controlled. Specifically, if

$$R = {\vert \frac{{n}_{f} - {n}_{ex}}{{n}_{f} + {n}_{ex}} \vert}^{2} ,$$

and R<<1, then

$${R}_{ex} ∼ 4 R \cdot {sin}^{2} ( \frac{δ}{2} ) ,$$

where δ(=4πn_{f}t/λ) is the round trip phase inside the external reflector. For example, for a thin film of TiO₂, R˜0.038, and an Rₑₓ˜4% is obtained for t˜518 Å. Therefore, by controlling Lₑₓ and Rₑₓ, one can independently adjust the modulation bandwidth of the extended cavity laser and the amount of optical feedback to the cavity of the DFB diode emitter.

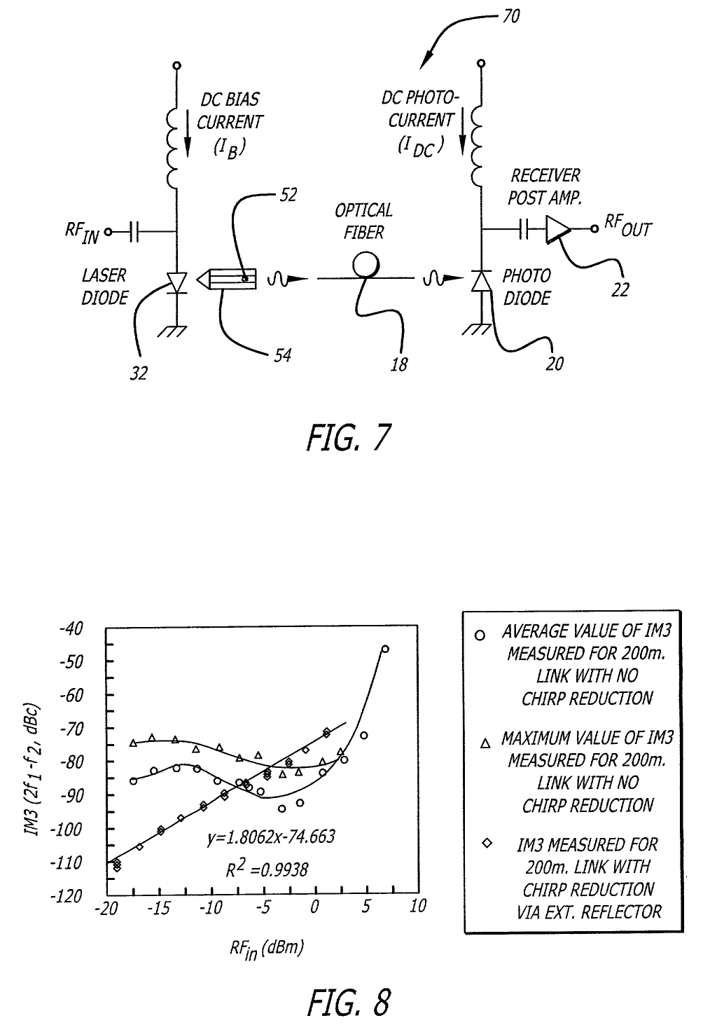

FIG. 7 is a diagram showing a directly modulated fiber optic transmission system using a laser transmitter with an external reflector in accordance with the present teachings. An RF input signal is transmitted by current modulation of the diode laser 32, coupled to a fiber pigtail 54 with an integrated external reflector 52. The fiber pigtail 54 transmits the signal to an optical fiber 18. The transmitted signal is then received by a photodetector 20 and post-amplifier 22.

Experimentally, reduction in frequency chirp with an external cavity laser was first observed using a diode laser of a Fabry-Perot design, and an external reflector fabricated from a UV-induced fiber grating (˜2.1 cm long). Specifically, a frequency chirp of ˜15 MHz/mA was measured, which is about one-tenth that of a DFB diode laser.

FIG. 8 is a graph showing a comparison of experimentally measured IM3 distortion for a directly modulated link with and without the chirp reduction technique of the present teachings. “Solid-dots” and “triangles” show the average and maximum values, respectively, of IM3 (in dBc) that was measured for a link where a conventional DFB laser (with no isolation or external reflector) was used as the optical source. As shown, the measured IM3 for the link with no chirp reduction or isolation follows a form that is predicted by [J₂(bₘ)J₁(bₘ)]². In fact, an IM3-maximum was typically observed for RF-input powers less than −5 dBm. If the power level of this IM3-maximum becomes higher than the system noise floor, it will degrade the SFDR of the analog link. In addition, there are significant fluctuations—possibly due to variations in the cos

$$cos ( \frac{{ω}_{m} {τ}_{d}}{2} )$$

part of bₘ—in the measured values of IM3.

The “diamond-shaped” data points in FIG. 8 show the IM3 measured for a DFB laser transmitter whose chirp has been reduced by coupling to an external reflector. As shown, the IM3 (in dBc) measured for such a link decreases linearly with the RF-input to the transmitter, with a well-behaved slope of ˜2 dB/dB. Notice that, with the low-chirp diode transmitter, the IM3 of the link was reduced by more than 25 dB for RF-input power levels that were less than −15 dBm. Finally, there was almost no measurable fluctuations in the detected IM3 of the link that employed the low chirp transmitter.

Experiments were also conducted using a fiber-integrated external reflector constructed by splicing a thin film of Si between two lengths of fiber, as described above.

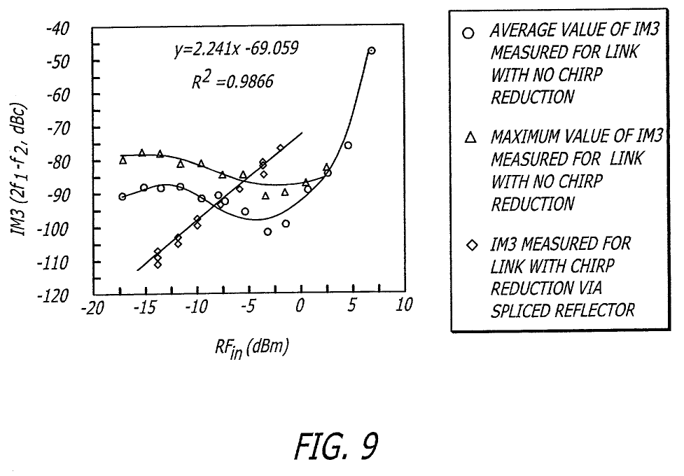

FIG. 9 is a graph showing a comparison of experimentally measured IM3 distortion for a directly modulated link with and without chirp reduction via a fiber-integrated external reflector. As shown, the IM3 (in dBc) measured for such a link decreased linearly with the RF-input to the transmitter, with a well-behaved slope of ˜2 dB/dB. Again, the measured IM3 (in dBc) was reduced by more than 25 dB for RF-input power levels that were less than −15 dBm.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A laser transmitter comprising:
a directly modulated diode laser and
means for reducing frequency chirp generated by said diode laser.

2. The invention of claim 1 wherein said means for reducing frequency chirp includes means for forming an external laser cavity with a long, passive section.

3. The invention of claim 2 wherein said means for forming an external laser cavity includes means for optically coupling said diode laser to an external reflector.

4. The invention of claim 3 wherein said external reflector is integrated into a fiber pigtail coupled to said diode laser.

5. The invention of claim 4 wherein said external reflector includes a thin film deposited onto the cleaved surface of a piece of fiber and spliced to a longer fiber length to form a fiber pigtail for said laser transmitter.

6. The invention of claim 5 wherein said thin film is comprised of silicon (Si).

7. The invention of claim 5 wherein said thin film is comprised of titanium oxide (TiO₂).

8. A laser transmitter comprising:
a directly modulated diode laser and
an external reflector optically coupled to said diode laser.

9. A directly modulated fiber optic transmission system comprising:
a laser transmitter comprising:
a directly modulated diode laser and
an external reflector optically coupled to said diode laser;
optical fiber which transmits the output of said laser transmitter; and
a photodetector for receiving the output of said laser transmitter from said optical fiber.

10. A method for minimizing the generation of interferometric intermodulation distortion in an analog fiber optic link that employs a directly modulated diode laser as its optical source including the steps of:
generating a directly modulated signal by a diode laser, and
coupling the diode laser to an external reflector, so that an external laser cavity with a long, passive section is formed.

11. The invention of claim 10 wherein said external reflector is integrated into a fiber pigtail coupled to said diode laser.

12. The invention of claim 10 wherein said external reflector includes a thin film deposited onto the cleaved surface of a piece of fiber and spliced to a longer fiber length to form a fiber pigtail.

13. The invention of claim 12 wherein said thin film is comprised of silicon (Si).

14. The invention of claim 12 wherein said thin film is comprised of titanium oxide (TiO₂).
